(19) United States
(12) Patent Application Publication
(10) Pub. No.: US 2012/0035316 A1
(43) Pub. Date: Feb. 9, 2012

(54) MACROMONOMERS AND GRAFT COPOLYMERS PREPARED BY EMULSION POLYMERIZATION WITH A COBALT CHELATE CHAIN TRANSFER AGENT

(75) Inventors: Saskia Carolien VAN DER SLOT, Waalwijk (NL); Tijs Nabuurs, Waalwijk (NL); Alfred Jean Paul BÜCKMANN, Waalwijk (NL); Gerardus Cornelis Overbeek, Waalwijk (NL)

(73) Assignee: DSM IP Assets B.V., Heerlen (NL)

(21) Appl. No.: 13/276,196

(22) Filed: Oct. 18, 2011

Related U.S. Application Data
(63) Continuation of application No. 11/587,402, filed on Feb. 8, 2007.

(30) Foreign Application Priority Data
Apr. 28, 2004 (GB) 0409448.8

(51) Int. Cl. C09D 133/24; C08F 216/04; C08F 222/20; C08F 216/14; C09D 133/14; C09D 135/02; C09J 133/24; C09J 133/14; C09J 135/02; C08F 216/36; C08F 293/00; B82Y 30/00

(52) U.S. Cl. 524/555; 526/93; 525/328.2; 525/328.6; 525/328.8; 525/328.9; 524/558; 977/773; 977/788; 977/902

(57) ABSTRACT

Process for preparing a macromonomer using free radical-initiated aqueous emulsion polymerisation in a polymerisation reactor of at least one olefinically unsaturated monomer, which process employs a hydrophobic Co chelate complex as a CTA, a stabilising substance(s) for the emulsion polymerisation process and a monomer feed stage MF;

wherein an aqueous pre-emulsified mixture A, comprising at least part of the Co chelate(s) employed, at least part of the stabilising substance(s) employed, and (i) a non-polymerisable organic solvent(s) and/or (ii) a polymerisable monomer(s) in unpolymerised or at least partially polymerised form, is contacted in the reactor with monomer(s) of feed stage MF at the beginning of and/or during the course of feed stage MF; and
wherein in mixture A the weight ratio of (i) and/or (ii) to the stabilising substance(s) is in the range of from 10/1 to 1/10.

This application is a continuation of commonly owned co-pending U.S. application Ser. No. 11/587,402, filed Oct. 24, 2006, which in turn is the national phase application under 35 USC §371 of PCT/EP2005/004407, filed Apr. 25, 2005 which designated the U.S. and claims priority to GB 0409448.8, dated Apr. 28, 2004, the entire contents of each of which are hereby incorporated by reference.

The present invention relates to a process for the preparation of a macromonomer using a free radical-initiated aqueous emulsion polymerisation of olefinically unsaturated monomer(s) in which a hydrophobic Co chelate catalyst(s) is used to control molecular weight.

Polymers of low molecular weight, known as oligomers, are often desired for various applications (such as coating compositions) either in their own right or as precursors for other polymers. In order to form oligomers it is necessary to appropriately control the polymerisation process being used to yield the desired type of product. In free-radical polymerisations, which are widely used for polymerising olefinically unsaturated monomer(s) (which may for convenience be called “olefinic monomer(s)”, “vinyl monomers” or “monomers” at various places in this specification), various conventional means are employed for controlling and limiting the molecular weight of the growing polymer chains. Of these, the addition of thiol compounds to the polymerisation has probably been used the most extensively; the thiol acts as an effective chain transfer agent but unfortunately contaminates the system to which it has been added by virtue of its distinctive and persistent odour.

More recently, attention has turned to the use of various transition metal complexes, particularly cobalt (Co) chelate complexes, as chain transfer agents for use in controlling molecular weight when free radically polymerising olefinic monomers.

For example, various literature references, such as N. S. Enikolopyan et al, J. Polym. Sci., Polym. Chem. Ed., Vol 19, 879 (1981), disclose the use of cobalt II porphyrin complexes as chain transfer agents in free radical polymerisation, while U.S. Pat. No. 4,526,945 discloses the use of dioxime complexes of cobalt II for such a purpose. Various other publications, e.g. U.S. Pat. No. 4,680,354, EP 0196783, EP 0755411, U.S. Pat. No. 4,694,059, and U.S. Pat. No. 5,962,609 describe the use of certain other types of cobalt II chelates as chain transfer agents for the production of oligomers of olefinically unsaturated monomers by free-radical polymerisation, the last mentioned of these concerning the use of certain substituted benzildioxime complexes of Co II. WO 87/03605 on the other hand claims the use of certain cobalt III chelate complexes for such a purpose.

The use of such Co chelate complexes as chain transfer agents may in many cases allow a considerably lower amount of chain transfer agent to be used for molecular weight reduction than the use of other known and established chain transfer agents such as thiols for comparable molecular weight reduction. Additionally, when polymerising certain types of monomer, these Co chelates allow the formation of a very high proportion of resulting oligomers having terminal unsaturation, known as macromonomers, inherently produced as a result of the catalytic chain transfer polymerisation (CCTP). (For ease of description, the entire polymeric product resulting from such CCTP and containing a high proportion of oligomers with terminal unsaturation is termed herein a macromonomer, i.e. collectively including not only the high proportion of oligomers with terminal unsaturation but any oligomers not having such terminal unsaturation). For example when an α-methyl vinyl monomer(s) is used as a monomer or comonomer in a (co)polymerisation of olefinic monomer(s), a terminally unsaturated low molecular weight macromonomer in known to be formed. Well known examples of such α-methyl vinyl monomers include methyl methacrylate, ethyl methacrylate, n-butyl methacrylate, hydroxyethyl methacrylate, methacrylamide, methacrylonitrile, and methacrylic acid, especially methyl methacrylate and/or ethyl methacrylate.

When conducting CCTP to form macromonomers one may use bulk, (organic) solution, aqueous suspension or aqueous emulsion polymerisation. Aqueous emulsion polymerisation is particularly beneficial, however, in that it generates polymer with a high level of macromonomer purity. In aqueous emulsion polymerisations as compared to polymerisations in organic solvent systems, more chain events are necessary to achieve similar molecular weight reduction. This results in the formation of a higher concentration of chains ending with a double bond.

Depending on the nature of the ligands surrounding the cobalt, the chelate complexes can have very different solubility characteristics in water. Thus some known Co chelate catalysts are hydrophilic, i.e. have solubility not only in organic monomers and solvents but also appreciably in water, while others are hydrophobic, i.e. have solubility substantially only in organic monomers and solvents and little or no solubility in water and therefore being present in proximity to where the chain transfer events occur. Furthermore, hydrophobic Co chelate catalysts may exhibit improved stability (see e.g. EP 755441).

When employing hydrophobic cobalt chelate complexes for CCTP in aqueous emulsion, it has been found that undesirably high amounts of the Co catalyst are required in order to achieve a very much lowered molecular weight in the resulting macromonomer (although these are still much lower in amount than hitherto used chain transfer agents such as thiols for comparable molecular weight reduction). This is particularly the case where the emulsion polymerisation process involves feeding the Co catalyst along with the monomer feed; such a process is currently favoured in CCTP-based aqueous emulsion polymerisation since dissolution of the Co catalyst in the monomer being fed allows accurate metering of the Co catalyst to be possible.

Such a disadvantage is not as marked when using hydrophilic Co chelate catalysts, even though they might possibly be inherently less efficient than some of the hydrophobic catalysts, and consequently this invention is only directed to using hydrophobic Co chelate catalysts.

It will be appreciated that the presence of such relatively high levels of Co catalyst is undesirable because of the typical colour they tend to impart to the product, the health and environmental aspects of the presence of heavy metals (in this case cobalt), and also the increased price of the products resulting from such higher levels of Co catalyst.

We have now invented a new process for CCTP in aqueous emulsion to form a macromonomer using a hydrophobic Co chelate catalyst, whereby such a process allows the preparation of very low molecular weight macromonomer using a very significant reduction of the amount of Co catalyst hitherto necessary to achieve comparable molecular weight reduction when using such a hydrophobic Co catalyst.

According to the present invention there is provided a process for preparing a macromonomer using free radical-initiated aqueous emulsion polymerisation in a polymerisation reactor of at least one olefinically unsaturated monomer, which process employs a hydrophobic Co chelate catalyst(s) as a catalytic chain transfer agent(s) for controlling molecular weight, a stabilising substance(s) for the emulsion polymerisation process, and a monomer feed stage MF in which olefinically unsaturated monomer(s) to be polymerised is fed to a polymerisation reaction medium in the reactor and polymerised therein;

and wherein an aqueous pre-emulsified mixture A, comprising at least part of the Co chelate(s) employed in the process, at least part of the stabilising substance(s) employed in the process, and (i) a non-polymerisable organic solvent(s) and/or (ii) a polymerisable olefinically unsaturated monomer(s) in unpolymerised or at least partially polymerised form, is contacted in the reactor with monomer(s) of feed stage MF at the beginning of and/or during the course of feed stage ME;
wherein in mixture A the weight ratio of (i) non-polymerisable organic solvent(s) and/or (ii) polymerisable olefinically unsaturated monomer(s) in unpolymerised or at least partially polymerised form to stabilising substance(s) is in the range of from 10/1 to 1/10.

It will be noted that there are two very closely related embodiments of the invention. In one, to be called herein embodiment G, pre-emulsified mixture A comprises a non-polymerisable organic solvent(s) (but no polymerisable olefinic monomer(s) in unpolymerised or at least partially polymerised form) (employing alternative (i) in the above statement of invention). In the other (employing alternative (ii)) to be called herein embodiment G′, pre-emulsified mixture A comprises a polymerisable olefinic monomer(s) in unpolymerised form or in at least partially polymerised form (but no non-polymerisable organic solvent(s)). As indicated above by the use of “and/or” language, it is also possible to use a combination of embodiment G and embodiment G′ (i.e. employing both alternatives (i) and (ii)). References or discussions relating to mixture A herein which do not mention embodiment G and/or embodiment G′ are intended to be applicable to both embodiments or the combination of these embodiments.

In the process of the invention, an aqueous pre-emulsified mixture A as defined above is contacted in the reactor with monomer(s) had in feed stage MF at the beginning of and/or during the course of feed stage MF. It is preferable for all of the aqueous pre-emulsified mixture A to be contacted in the reactor with monomer(s) of feed stage MF at the beginning of the feed stage (with contact being with the first part of the monomer(s) feed in feed stage MF, particularly if fed over a prolonged period), in which case mixture A can be made up in the polymerisation reactor before the start of the feed stage MF, or can be prepared outside the reactor (e.g. in another vessel) and added to the reactor before the start of or contemporaneously with the start of feed stage ME. Mixture A could conceivably, in such case, be partially made up inside and partially outside of the reactor.

Such a mixture A which is all contacted in the reactor with the monomer being fed in stage MF at the beginning of this feed stage could advantageously provide the, or a major part of the, initial polymerisation reaction medium, provided other required components, such as an initiator(s), are also present or are subsequently added thereto.

It is also optionally possible for all of the mixture A to be first contacted in the reactor with monomer(s) of feed stage MF during the course of this monomer(s) feed, i.e. after the commencement of the feed stage. In such case it would be necessary to prepare mixture A outside the reactor (e.g. in a separate vessel) and add it to the polymerisation medium in the reactor at the desired time of first contact.

It is further possible for part of the mixture A to be contacted with the monomer(s) of feed stage MF at the start of the feed stage and the rest of mixture A to be contacted with monomer(s) of feed stage MF during the course of the feed stage MF (it being understood that any part of mixture A contacted during the course of the feed stage MF would have to be prepared outside the reactor).

It will thus be appreciated that the pre-emulsified mixture A can be contacted in the reactor with monomer(s) of feed stage MF at any convenient point of the feed stage, but preferably when ≦50 weight % of the monomer(s) of feed stage MF has been fed to the reactor, more preferably when ≦10 weight % of the monomer(s) has been fed, and most preferably (as discussed above) at the beginning of feed stage MF.

Additionally, if mixture A comprises a polymerisable olefinically unsaturated monomer(s) in at least partially polymerised form, and preferably in substantially fully polymerised form, mixture A may be stored and used at a later time in the invention process, preferably being stored for at least 1 day, more preferably 3 days to 1 year, before subsequent use in the invention process.

In embodiment G of the invention process, the non-polymerisable organic solvent(s) used for the pre-emulsified mixture A preferably dissolves the Co chelate(s) used in mixture A. Preferably, at least one of the organic solvents (if more than one is used) is of very limited water solubility, preferably having a water-solubility of ≦5 cm³/100 g of water, more preferably ≦2 cm³/100 g of water and most preferably ≦1 cm³/100 g of water. Examples of non-polymerisable organic solvent(s) which could be used include, but are not limited to, aromatic hydrocarbons such as benzene, toluene and the xylenes; linear alkanes such as pentane, hexane, nonane and decane; linear alcohols such as hexanol, Texanol (Eastman Kodak), Lusolvan FBH (BASF), Coasol B (Chemoxy); and 2-ethylhexyl acetate. The organic solvent(s) may optionally contain other hydrophobic compounds provided that the viscosity of the mixture at the emulsification temperature is acceptably low (preferably below 100 Pa·s).

In embodiment G′, the pre-emulsified mixture A comprises a polymerisable olefinic monomer(s) which can be in unpolymerised form before contact of mixture A in the reactor with monomer(s) of feed stage MF, or can be in at least partially polymerised form, i.e. such monomer(s) in the latter case being partly or substantially fully polymerised (the term “substantially” is used here because it is difficult to take any polymerisation to absolutely 100% completion) before mixture A is contacted in the reactor with monomer(s) of feed stage MF—and such polymerisation could e.g. be effected inside or outside of the reactor as desired or appropriate. It is preferred in the invention process to use embodiment G′ in which the polymerisable olefinic monomer(s) in mixture A is (are) in unpolymerised form before mixture A is contacted in the reactor with monomer(s) of feed stage MF (although of course polymerisation will certainly take place subsequently, along with the monomers of feed stage MF) rather than a non-polymerisable organic solvent(s) (embodiment G), although the alternative of partly or substantially fully polymerised monomer(s) that can be used in embodiment G′ before contact of mixture A with monomer(s) of feed stage MF is equally if not more preferred, and compares favourably to the use of unpolymerised monomer(s) for the purposes of the invention and indeed may possess an additional advantage in that the mixture could stand for a longer period (say several months) without the Co catalyst efficiency becoming impaired.

The olefinic monomer(s) employed in mixture A of embodiment G′ (whether in unpolymerised form or in at least partially polymerised form) is to be considered as part of the olefinically unsaturated monomer(s) to be polymerised in the invention process. Such a monomer(s) would normally be the same as one or more or all of those that are fed in the feed stage MF, but could in principle be a different olefinically unsaturated monomer(s).

It will be appreciated that desirable solvent properties regarding polymerisable monomer(s) used for mixture A in embodiment G′, whether unpolymerised or at least partially polymerised before contact of mixture A in the reactor with the monomer(s) of feed stage MF, will preferably be the same or similar to those of the non-polymerisable organic solvent(s) employed in mixture A for embodiment G. Thus in the alternative of embodiment G′ where the monomer(s) is unpolymerised before contact with feed stage MF, the olefinic monomer(s) used for mixture A preferably dissolves the Co chelate(s) present, so emulsified monomer(s) containing dissolved Co catalyst(s) would be formed, stabilised with the stabilising substance(s). In the alternative of embodiment G′ where the monomer(s) of mixture A is at least partially polymerised before contact with feed stage MF, the monomer(s) thereof again preferably dissolves the Co chelate(s) before the at least partial polymerisation takes place.

In view of this at least one of the monomers used in mixture A, embodiment G′ (if more than one is used), is preferably (as for the non-polymerisable organic solvent(s) of embodiment G) of limited water solubility and preferably the at least one monomer has a water-solubility of ≦5 cm³/100 g of water, more preferably ≦2 cm³/100 g of water, and most preferably ≦1 cm³/100 g of water. As mentioned above, the monomer(s) used is preferably the same as one or more of those used in feed stage MF. Suitably monomer(s) used in embodiment G′ of mixture A preferably include one or more of methyl methacrylate, ethyl methacrylate, and n-butyl methacrylate, more preferably methyl methacrylate and/or ethyl methacrylate. The monomer(s) may optionally contain other hydrophobic compounds provided that the viscosity of the mixture at the emulsification temperature is acceptably low (preferably below 100 Pa·s).

As mentioned above, it is also within the scope of the invention to employ a combination of embodiments G and G′ in the process of the invention, so that mixture A (before contact with the monomer(s) of feed stage MF) contains a non-polymerisable organic liquid and either an unpolymerised monomer(s) or an at least partially polymerised monomer(s).

In embodiments G and/or G′ the Co chelate catalyst(s) in mixture A becomes (it is thought) finely dispersed, whether present dissolved in emulsified non-polymerisable organic solvent (as in embodiment G it is thought) or dissolved in emulsified monomer droplets (as in the first mentioned option of embodiment G′ it is thought) or adsorbed in polymerised polymer particles (as in the second mentioned option of embodiment G′ it is thought). In any case, once monomer feed stage MF is underway, and polymerisation of the monomer(s) fed via feed stage MF in the reactor has commenced, the status of the monomer(s)/Co catalyst(s) of mixture A in both alternatives of embodiment of G′ will (it is thought) tend to become essentially the same.

The effectiveness (i.e. efficiency) of a hydrophobic Co chelate catalyst when used as part of a pre-emulsified mixture A in the invention process has been found to be generally 5 to 30 times greater than that of the same amount of the same Co chelate present only in, or separately fed with, the monomer(s) to be polymerised in feed stage MF.

The components of aqueous pre-emulsified mixture A comprising Co chelate catalyst(s), (i) non-polymerisable organic solvent(s) and/or (ii) polymerisable monomer(s) in unpolymerised or at least partially polymerised form, and stabilising substance(s) may be brought together in any order, using any appropriate agitation means to effect emulsification in water of the nonaqueous components, such as an effective stirrer or homogenisation equipment. The agitation for emulsification is usually effected at ambient temperatures (ambient or room temperature is taken herein as 10 to 40° C.) although emulsification at higher temperatures is possible.

The prefix “pre” in “pre-emulsified mixture” is used to emphasise that such mixture is separately formed from the monomer(s) had in feed stage MF and normally formed before the start of the MF feed stage.

By the term “emulsified” in “pre-emulsified mixture” is meant that there are dispersed in water colloidally sized droplets of non-polymerisable organic solvent(s) and/or unpolymerised monomer(s) containing dissolved Co catalyst(s) or, in the case where monomer(s) which has dissolved the Co catalyst has been at least partially polymerised before contact in the reactor with monomer(s) of feed stage MF, colloidally sized particles of polymer containing Co catalyst(s) disposed therein, together with any intermediate states arising from partially polymerised monomer(s), the droplets and/or particles (and/or any intermediate states if monomer(s) used is partially polymerised before contact in the reactor with monomer(s) of feed stage MF) being stabilised with the stabilising substance(s).

As mentioned above, this invention is not intended to cover using hydrophilic Co chelate catalysts where the advantage of using the invention process is much less apparent.

There is further provided according to the invention a macromonomer which has been formed using a process as defined above. Such a macromonomer may contain a very small amount of hydrophobic Co chelate catalyst(s) because such a catalyst(s) can be used in significantly reduced quantity in the invention process than hitherto necessary to achieve comparable very low molecular weight. Preferably, the process according to the invention uses, and the macromonomer resulting therefrom contains, essentially ≦100 weight parts per million (ppm) of the Co chelate catalyst(s) based on the total weight of monomer(s) used for the polymerisation (including any used in mixture A as well as in feed stage MF), preferably ≦60 weight ppm, more preferably ≦35 weight ppm, and most preferably ≦20 weight ppm.

The process of the invention involves the use of aqueous emulsion polymerisation to form colloidal-sized macromonomer particles dispersed in water. The use of aqueous suspension polymerisation, thereby to form granules or beads, is excluded, as is aqueous microsuspension polymerisation (also known as mini-emulsion polymerisation) where microdroplets of monomer are formed using homogenising apparatus or selected cosurfactants and then polymerised, since in this latter case although an aqueous emulsion of colloidal-sized polymer particles can result, there are no new particles formed in the polymerisation process whereas in the present invention secondary nucleation to form new particles has been observed to occur during the polymerisation (a known characteristic of aqueous emulsion polymerisation but not microsuspension polymerisation).

The aqueous emulsion polymerisation of the invention process preferably results in a macromonomer aqueous emulsion of particle size, as measured with light scattering equipment, within the range of from 10 to 300 nm, more preferably from 15 to 200 nm, and particularly from 20 to 150 nm. The solids content of the resulting macromonomer aqueous emulsion is usually within the range of from 10 to 50 weight % and more preferably from 20 to 45 weight %.

The aqueous emulsion of macromonomer resulting from the invention process may be stored or used as such (with optional dilution with water or optional concentration), or (less preferably) the macromonomer may first be isolated before subsequent use or before storing.

The amount of Co catalyst employed in mixture A is preferably 10 to 100 weight % based on the total weight of Co catalyst employed in the invention process, more preferably 50 to 100 weight % (and bearing in mind that the preferred total absolute amount of Co chelate catalyst used is, as mentioned above, essentially ≦100 weight ppm based on total weight of monomer(s) used for the polymerisation, more preferably ≦60 weight ppm, more preferably ≦35 weight ppm and most preferably ≦20 weight ppm). The remaining Co catalyst, if any (since all may, if desired, be used in the mixture A), is added separate to and usually after the introduction of mixture A to the reactor.

The maximum amount of Co catalyst in the mixture A when (co)polymerising an α-methyl vinyl monomer(s) of formula II (see later for this formula) is preferably governed by the following empirical relationship:

Mw[Co-complex]/m^{1/2}≦0.35 Dalton I

where
Mw is the achieved weight average molecular weight of the macromonomer in Dalton;
[Co-complex] is the concentration Co chelate catalyst(s) in mixture A in mol ppm based on total monomer(s) used in the invention process; and
m is the average number of carbon atoms of the alkyl, aryl or aralkyl substituent(s) of the α-methyl vinyl monomer(s) (or the weight average number of the number of carbon atoms of such substituents if using more than one α-methyl vinyl monomer).

Molecular weights of oligomers, macromonomers and polymers as specified herein are those determined using gel permeation chromatography (GPC) relative to polymers of known molecular weight. GPC is calibrated according to polystyrene standards.

The amount of (i) non-polymerisable organic solvent(s) and/or (ii) polymerisable olefinic monomer(s) used for mixture A (whether in unpolymerised form or in at least partially polymerised form in the case of embodiment G′), is preferably within the range of from 1 to 20 weight % based on total amount of monomer(s) used for the polymerisation, more preferably from 2 to 10 weight % and particularly from 2.5 to 7.5 weight %. Thus it will be noted that the (i) non-polymerisable organic solvent(s) and/or (ii) polymerisable monomer(s) in unpolymerised or at least partially polymerised form used for mixture A is preferably only a small fraction of the total monomer(s) employed for the invention polymerisation process (i.e. including that of feed stage ME as well as that for mixture A in embodiment G′).

The weight ratio of (i) non-polymerisable organic solvent(s) and/or (ii) polymerisable monomer(s) (whether in unpolymerised or at least partially polymerised form in embodiment G′) to stabilising substance(s) in mixture A is preferably in the range of from 5/1 to 1/5 (weight/weight) and particularly from 3/1 to 1/3 (weight/weight). It will be noted that the preferred concentration of stabilising substance(s) in mixture A is very high with amounts of 25 to 75 weight % or more based on (i) non-polymerisable organic solvent(s) and/or (ii) polymerisable monomer(s) (whether in unpolymerised or at least partially polymerised form) present as the case may be not being unusual.

The stabilising substance(s) employed in mixture A may be a surfactant(s) or a hydrophilic oligomer(s). Combinations of these may also be used.

A wide range of surfactants may be used such as those commonly employed in aqueous emulsion polymerisation of olefinically unsaturated monomers. They may be of the ionic type, including anionic or cationic, or of the nonionic type. Combinations of ionic and nonionic surfactants may also be used, especially combinations of anionic and nonionic surfactants.

Suitable surfactants include but are not limited to conventional anionic, cationic and/or nonionic surfactants and mixtures thereof, such as Na, K and NH₄ salts of dialkylsulphosuccinates, Na, K and NH₄ salts of sulphated fatty acids or fatty alcohols, Na, K and NH₄ salts of alkyl sulphonic acids, Na, K and NH₄ alkyl sulphates, alkali metal salts of sulphonic acids; fatty alcohols, ethoxylated fatty acids and/or fatty amides, and Na, K and NH₄ salts of fatty acids such as Na stearate and Na oleate. Other anionic surfactants include alkyl or (alk)aryl groups linked to sulphonic acid groups, sulphuric acid half ester groups (linked in turn to polyglycol ether groups), phosphonic acid groups, phosphoric acid analogues and phosphates or carboxylic acid groups. Cationic surfactants include alkyl or alkaryl groups linked to permanent quaternary ammonium salt groups or protonated tertiary amino groups. Nonionic surfactants include polyglycolether compounds and preferably polyethylene oxide compounds as disclosed in “Non-Ionic Surfactants—Physical Chemistry” edited by M. J. Schick, M. Decker 1987.

The amount of surfactant(s) if used in mixture A is preferably within the range of from 0.1 to 5 weight % based on total monomer(s) used in the invention polymerisation process, more preferably from 0.5 to 5 weight % and particularly from 1 to 3 weight %. Additional surfactant(s) to that in the mixture A could also if desired be employed during the polymerisation reaction of the monomer(s) of monomer feed stage MF (not necessarily but usually the same as that used in mixture A), e.g. by feeding during the MF feed, in order to further stabilise the macromonomer particles being formed.

By hydrophilic oligomers is meant herein oligomers (i.e. low molecular weight polymers) which possess the property of self-dispersibility in water (i.e. dispersible in water without the need to use external surfactant(s)), preferably being self-dispersing acrylic or urethane oligomers or combinations of the two. They are usually self-dispersing oligomers of olefinic monomers, particularly acrylic oligomers or polyurethane oligomers, but can also be self-dispersing oligomers of any suitable type, e.g. self-dispersing polyester polymers. This property of self-dispersibility is achieved by the presence of self-dispersing groups in the oligomer, which can be introduced directly into the oligomer during the polymerisation to form it by including monomer(s) carrying such groups, or functional groups may first be introduced into the oligomer which can be subsequently reacted to form a self-dispersing groups. Some dispersing groups, such as carboxylic acid groups (e.g. from (meth)acrylic acid often used as water-dispersing monomer) can perform more than one function, e.g. (meth)acrylic acid is often used as a water-dispersing monomer, but can also act as a crosslinking monomer if suitable conditions are present (such as the presence of co-reactive crosslinking groups in the system for example from an added crosslinking agent or the presence of co-reactive groups in the oligomer, or both). Ionic water-dispersing groups may need to be at least partly in their dissociated form to effect their water-dispersing action; e.g. acid groups such as carboxylic acid may need to be treated with a base such as ammonia, or volatile organic amine, or Na, Li, or K hydroxide if of insufficiently low pK to be dissociated in water. If they are not dissociated they are considered as potential ionic groups which become ionic upon dissociation. The ionic water-dispersing groups are preferably fully or partially in the form of a salt when used in the invention. Ionic and potentially ionic water-dispersing groups include cationic water-dispersing groups such as basic amine groups, quaternary ammonium groups and anionic water-dispersing groups such as acid groups, for example phosphoric acid groups, sulphonic acid groups and (most preferably) carboxylic acid groups.

Preferred olefinically unsaturated monomers providing anionic or potentially anionic water-dispersing groups include (meth)acrylic acid, itaconic acid, maleic acid, β-carboxyethyl acrylate, monoalkyl maleates (for example monomethyl maleate and monoethyl maleate) and citraconic acid. Acrylic acid and methacrylic acid are particularly preferred. If the macromonomer to be formed in the invention process is to bear carboxylic acid groups derived from unsaturated acids such as acrylic acid or methacrylic acid, it may be necessary that any unsaturated acids used in the formation of a hydrophilic oligomer has a pKa value below that of acrylic acid or methacrylic acid, for example phosphated hydroxyethyl methacrylate, sulphonated styrene, sulphated hydroxylethyl methacrylate and salts thereof, 2-acrylamido-3-methylpropane sulphonic acid (AMPS) (Lubrizol), Sipomer PAM-100 and Sipomer PAM-200 (Rhodia) (thereby reducing the likelihood of an acid functional hydrophilic oligomer used as stabilising substance in the invention process itself becoming destabilised).

A preferred monomer for providing self-dispersing groups in polyurethane polymers is dimethyl propionic acid (DMPA). Others which may be used include sodio-5-sulpho isophthalic acid (SSIPA) and diethyleneglycol SSIPA (Eastman Chemicals).

Non-ionic water-dispersing groups may be in-chain, pendant or terminal groups. Preferably non-ionic water-dispersing groups are pendant polyoxyalkylene groups, more preferably polyoxyethylene groups. Preferred ethylenically unsaturated monomers providing non-ionic water-dispersing groups include alkoxy polyethylene glycol (meth)acrylates, hydroxy polyethylene glycol (meth)acrylates, alkoxy polypropylene glycol (meth)acrylates and hydroxy polypropylene glycol (meth)acrylates, preferably having a number average molecular weight of from 350 to 3000. Examples of such monomers which are commercially available include ω-methoxypolyethyleneglycol (meth)acrylate. Other olefinically unsaturated monomers providing water-dispersing groups include (meth)acrylamide, hydroxyalkyl (meth)acrylates such as hydroxyethyl methacrylate, acetoacetoxylethyl methacrylate, diacetonacrylamide and acetoacetoxy methacrylamide.

Preferably acid monomers are employed for providing self-dispersibility in such hydrophilic oligomers, typically methacrylic acid or acrylic acid, in the cases of olefinic oligomers (i.e. oligomers formed by polymerisation of olefinically unsaturated monomers) and DMPA in the case of urethane polymers. Preferably, in such cases, the acid concentration of the oligomer is provided by 2 to 40 weight % of acid monomer(s) based on total monomer(s) to make the oligomer (more than one acid monomer could of course be used), more preferably 2 to 25 weight % and particularly 4 to 12 weight %. Other non-acid hydrophilic monomers, such as those mentioned above could also be used with the acid monomer(s) to form the oligomer, such as diacetoneacrylamide, methacrylamide or polyethylene glycol (PEG) functional monomers. The same preferred ranges as used above for acid monomer(s) would also be applicable for non-acid hydrophilic monomer(s) if used (weight % based on total monomer(s) used to make the oligomer).

The weight average molecular weight of the hydrophilic oligomer (if used) is preferably in the range of from 1 to 200 kD (D=Dalton), more preferably 2 to 130 kD, more preferably 2 to 60 kD and particularly 5 to 25 kD. Lowering of molecular weight to achieve an oligomer could be effected by employing a chain transfer agent in the polymerisation reaction. Examples include mercaptans and halogenated hydrocarbons, for example mercaptans such as n-dodecylmercaptan, n-octylmercaptan, t-dodecylmercaptan, mercaptonethanol, iso-octyl thioglycolate, C₂ to C₈ mercapto carboxylic acids and esters thereof such as 3-mercaptopropionic acid and 2-mercaptopropionic acid; and halogenated hydrocarbons such as carbon tetrabromide and bromotrichloromethane. A catalytic chain transfer agent such as a cobalt chelate complex could also be used, in which case it is possible that the hydrophilic oligomer (if used) in mixture A could itself be a macromonomer.

The amount of hydrophilic oligomer (if used) in mixture A is preferably within the range of from 0.2 to 20 weight % based on the total amount of monomer(s) employed in the invention polymerisation process, preferably from 0.5 to 10 weight % and particularly from 1 to 5 weight %.

Surfactant(s) and hydrophilic oligomer(s) could be used in combination in mixture A, in which case the maximum amounts used could be appropriately lowered from the preferred amounts of both mentioned above although such preferred ranges as mentioned above could still be used. As mentioned above, combinations of different hydrophilic oligomers (e.g. acrylic and polyurethane hydrophilic oligomers) can also be used.

It will be apparent from the foregoing that in a particularly preferred variant of embodiment G′ of the invention process there is provided a process for preparing a macromonomer using free radical-initiated aqueous emulsion polymerisation in a polymerisation reactor of at least one olefinically unsaturated monomer, which process employs a hydrophobic Co chelate catalyst(s) as a catalytic chain transfer agent(s) for controlling molecular weight, a stabilising substance(s) for the emulsion polymerisation process, and a monomer feeding stage MF in which olefinically unsaturated monomer(s) to be polymerised is fed to a polymerisation reaction medium in the reactor and polymerised therein,

and wherein an aqueous pre-emulsified mixture A, comprising at least part of the Co chelate employed in the process, at least part of the stabilising substance(s) employed in the process, and part of the monomer(s) to be polymerised which is in at least partially polymerised form, is prepared in or added to the reactor prior to the commencement of the monomer feed stage MF.

In the above variant of embodiment G′, the aqueous emulsion of mixture A may be made up in the polymerisation reactor or may be prepared separately and added thereto (this is intended to include the case where some of mixture A is prepared in the reactor and the rest of mixture A is prepared outside the reactor and added thereto). The initially dispersed monomer(s) dissolves the Co chelate(s), the polymerisation of this monomer(s) is initiated, and then after a reasonably short period of time (e.g. preferably ≦60 minutes, more preferably ≦30 minutes and most preferably 2 to 15 minutes) the monomer(s) of monomer feed stage MF is had to the polymerisation reactor and its polymerisation therein commenced (during this feeding period the monomer(s) of mixture A may or may not have finished polymerising).

The monomer(s) fed to the reactor in feed stage MF of the invention process may be fed over a significant period of time, e.g. over about 20 to 480 minutes, more preferably over about 30 to 360 minutes and most preferably over about 120 to 255 minutes. It would also be possible to feed it very quickly (all in one go) to the polymerisation medium in the reactor, so that the polymerisation would then effectively be a batch polymerisation. Other polymerisation methods that are suitable for this purpose include sequential or power feed polymerisation (the latter type of polymerisation being described in U.S. Pat. No. 3,804,881 and U.S. Pat. No. 4,195,167). In these cases it will be appreciated that two or more different feeds are employed which preferably differ in monomer composition. The difference may be such as to introduce different properties in the different oligomer phases, including different Tg's, different functional monomers, different concentrations of functional monomers, and combinations of these.

The free radical yielding initiator may be any one (or more) of those known to be useful for the aqueous emulsion polymerisation of olefinically unsaturated monomers. Suitable examples include organic peroxides such as K. Na or ammonium persulphate, hydrogen peroxide, or percarbonates, organic peroxides such as acyl peroxides including e.g. benzoyl peroxide or lauroyl peroxide, alkyl hydroperoxides such as t-butyl hydroperoxide and cumene hydroperoxide; dialkyl peroxides such as di-t-butyl peroxide; peroxy esters such oat-butyl perbenzoate and the like; mixtures may also be used. The peroxy compounds are in some cases advantageously used in combination with suitable reducing agents (redox systems) such as Na or K pyrosulphite or bisulphite, and iso-ascorbic acid. Metal compounds such as Fe.EDTA (EDTA is ethylene diamine tetracetic acid) may also be usefully employed as part of the redox initiator system. Azo functional initiators may also be used, examples of which include azobis(isobutyronitrile) and 4,4′-azobis(4-cyanovaleric acid). Preferred initiators include ammonium persulphate, sodium persulphate, potassium persulphate, azobis(isobutyronitrile) and 4,4′-azobis(4-cyanovaleric acid). Most preferred are Na, K. and ammonium persulphates.

The initiator may be included entirely or substantially entirely with mixture A (or added thereto). It may also be separately added to the reactor to initiate polymerisation of the had monomer(s) of feed stage MF. It may also be partly in mixture A and partly separately added to the polymerisation reactor. However it is preferred to feed most if not all the initiator used to the polymerisation medium in the reactor (combined with and/or separately from the monomer(s) of feed stage MF). The initiator if added to the polymerisation medium in the reactor is preferably fed as separate feed to the monomer(s) of feed stage MF so that its feed time may be varied opposite the time of the monomer(s) feed (shorter or longer as well as the same).

The amount of initiator (or initiator system in cases where more than one initiator component is used, as in e.g. redox systems) is preferably within the range of from 0.05 to 5 weight %, based on the total weight of monomer(s) used in the invention process, more preferably from 0.1 to 3 weight %, and particularly from 0.3 to 1.5 weight % (typically 0.5 to 0.75 weight %).

The polymerisation medium in the reactor is usually heated to effect free radical-initiated polymerisation, with temperatures within the range of 30 to 100° C. being typical for many free radical initiators (more usually 30 to 90° C.). A further amount of initiator may optionally be added at the end of polymerisation to assist the removal of residual monomer(s).

Examples of olefinically unsaturated monomers which may be used to form the macromonomers (some of which have already been mentioned above) include olefinically polyunsaturated monomers such as 1,3-butadiene isoprene; polyalkylene glycol di(meth)acrylates such as 1,3-butyleneglycol diacrylate, ethylene glycol diacrylate; divinyl benzene; monolefinically unsaturated monomers include styrenes such as styrene itself; α-methyl styrene and t-butyl styrene; meth(acrylic) amides and (meth)acrylonitrile; vinyl halides such as vinyl chloride; vinylidine halides such as vinylidene chloride; fluoro-containing vinyl monomers such as trifluoro ethyl methacrylates; vinyl ethers; vinyl esters such as vinyl acetate, vinyl propionate, vinyl laurate and vinyl esters of versatic acid such as VeoVa 9 and VeoVa 10 (VeoVa is a trademark of Resolution); heterocyclic olefinically unsaturated compounds; olefinically unsaturated acids such as acrylic acid, methacrylic acid, β-carboxyethyl acrylate and citraconic acid; alkyl esters of mono-olefinically unsaturated dicarboxylic acids such as di-n-butyl maleate and di-n-butyl fumarate and, in particular, esters of acrylic acid and methacrylic acid of formula CH₂═CR¹—COOR² wherein R¹ is H or methyl and R² is optionally substituted alkyl of 1 to 20 carbon atoms (more preferably 1 to 8 carbon atoms) or cycloalkyl of 5 to 20 carbon atoms (more preferably 5 to 8 carbon atoms) examples of which are methyl (meth)acrylate, ethyl (meth)acrylate, butyl (meth)acrylate (all isomers), octyl (meth)acrylate (all isomers but particularly 2-ethylhexyl (meth)acrylate), isopropyl (meth)acrylate, n-propyl (meth)acrylate, and hydroxyalkyl (meth)acrylates such as hydroxyethyl (meth)acrylate, 2-hydroxypropyl (meth)acrylate, 4-hydroxybutyl (meth)acrylate and their modified analogues like Tone M-100 (Tone is a trademark of Union Carbide Corporation). Such monomers of formula CH₂═CR¹—COOR² when R¹═H are usually known as acrylate monomers and when R¹=methyl are usually known as methacrylate monomers. The corresponding macromonomers containing at least 40 weight % of such polymerised monomer units are herein called acrylic macromonomers (i.e. whether derived from acrylate or methacrylate monomers or both).

In order to obtain a macromonomer, i.e. an oligomer having a high proportion of terminal unsaturation in its polymer chains (preferably at least 80% of the chain having terminal unsaturation, more preferably at least 90%), it is preferable to employ at least 20 weight % of at least one (co)polymerisable α-methyl vinyl monomer for the monomer(s) used to make the macromonomer, more preferably at least 50 weight % and particularly at least 80 weight % (based on total monomer weight used for the polymerisation).

By a (co)polymerisable α-methyl vinyl monomer is meant herein a monomer of formula

CH₂═C(CH₃)-Q II

where Q is the residue of the monomer molecule and is preferably selected from one or more of: a carbon acid group of formula C(═O)OR³ or a carbon amide group of formula C(═O)ONHR³ where R³ is H, optionally substituted C₁₋₁₈ alkyl, optionally substituted aryl (more preferably phenyl and methyl substituted phenyl) and optionally substituted alkaryl; CN; and optionally substituted aryl (more preferably phenyl or methyl substituted phenyl).

Suitable α-methyl vinyl monomers (some of which have already been mentioned above) include, for example, methacrylic acid, methacrylate esters, such as C₁ to C₁₈ normal or branched alkyl esters of methacrylic acid, including methyl methacrylate, ethyl methacrylate, n-butyl methacrylate, isopropyl methacrylate, cyclohexyl methacrylate, 2-ethylhexyl methacrylate (all isomers), isobornyl methacrylate, lauryl methacrylate and stearyl methacrylate; hydroxyalkyl methacrylates such as hydroxethyl methacrylate; glycidylmethacrylate; phenyl methacrylate; methacrylamide; methacrylonitrile; triethyl fluoro methacrylate; alpha methyl styrene; polyethyleneglycol(PEG) methacrylates; methoxypolyethylenglycol(MPEG) methacrylates, or combinations thereof.

Preferably the monomers used to form the macromonomer include an olefinically unsaturated acid monomer(s) preferably in an amount within the range of from 5 to 20 weight %, more preferably from 5 to 12 weight % based on the total amount of monomers used.

The ethylenically unsaturated monomers used to make the macromonomers may also include, if desired, monomers carrying functional groups such as crosslinker groups and/or hydrophilic water dispersing groups (as discussed above in respect of the oligomeric stabilising substance(s) which may be used in the invention process). Such functionality may be introduced directly in the macromonomer by free radical polymerisation, or alternatively the functional group may be introduced by a reaction of a reactive monomer which is subsequently reacted with a reactive compound carrying the desired functional group. Some functional groups may perform more than one function, for example (meth)acrylic acid is usually used as a water-dispersing monomer however it may also act as a crosslinking monomer. Such variations are known to those skilled in the art.

Water-dispersing groups and water-dispersing monomers have been discussed above in respect of an oligomeric stabilising substance and similar considerations apply here with the proviso that it is not of course necessarily required to use any ionic dispersing monomer(s) in dissociated form, or indeed to use (if used at all) a sufficient amount of any dispersing monomer, to achieve the property of self-dispersibility (very small amounts could be used, or indeed none could be used).

Examples of suitable water-dispersing groups and water-dispersing monomers have been mentioned above in respect of the stabilising substance when it is an oligomer and these groups could also be used in the formation of the macromonomer, with acrylic acid and methacrylic acid being usually preferred in practice as the water-dispersing monomers (if used at all of course).

The macromonomer formed in the invention process may, if desired, possess functional groups for imparting latent crosslinkability to an aqueous composition containing or derived from the macromonomer (latent crosslinkability means that crosslinking takes place during and/or after the aqueous composition is subsequently dried) either when combined with an added crosslinking agent or by reaction with coreactant groups also present in the macromonomer or other added polymer or by application of suitable radiation (combinations of two or more such techniques could also be used). The macromonomer could e.g. be combined with a crosslinking agent after its preparation said crosslinking agent being reactable with crosslinkable groups also present in macromonomer molecules (or from other polymers of the composition) during and/or after drying of the composition to effect crosslinking. For example, the macromonomer could carry groups such as hydroxyl groups and the composition subsequently formulated with a crosslinking agent such as a polyisocyanate, melamine, or glycoluril; or the functional groups on the macromonomer could include keto, aldeyde and/or acetoacetoxy carbonyl groups and the subsequently formulated crosslinker could be a polyamine or polyhydrazide such as adipic acid dihydrazide, oxalic acid dihydrazide, phthalic acid dihydrazide, terephthalic acid dihydrazide, isophorone diamine, 4,7-dioxadecane-1,10-diamine, or Jeffamine-T-403; or a crosslinker carrying semi-carbazide or hydrazide functional groups. Silane functional crosslinking agents such as the anninoalkyl silane Silquest A-1110 (Witco) could also be used. Alternatively the macromonomer could contain hydrazide functional groups and the subsequently formulated crosslinker could contain keto functional groups. The functional groups could include silane functional groups or hydroxyl functional groups reactive with silane groups, and the subsequently formulated crosslinker could also comprise silane functional groups. The functional groups could also be unsaturated double bonds which undergo polymerisation to cause crosslinking on the application of suitable radiation (e.g. u.v. radiation).

Suitable monomers carrying crosslinker groups include for example allyl, glycidyl or hydroxyalkyl (meth)acrylates, acetoacetoxy esters, acetoacetoxy amides, keto and aldehyde functional vinyl monomers, keto-containing amides such as diacetone acrylamide, methylol and silane functional (meth)acrylic monomers.

Preferred crosslinking mechanisms (if used) include silane functional group crosslinking and keto functional group with hydrazide functional group crosslinking.

The resulting macromonomer may optionally comprise functional monomers that act as adhesion promoters, such as Sipomer WAM (Rhodia), Cylink C4 (Cytec), and Norsocryl 104 (Atofina), or monomers with long alkyl chains, such as lauryl (meth)acrylate and stearyl (meth)acrylate or adhesion promoters such as β-naphthyl methacrylate (some of these have already been mentioned above).

Preferably the weight average molecular weight of the macromonomer is in the range of from 2,000 to 100,000 Dalton, more preferably 5,000 to 50,000 Dalton and most preferably 8,000 to 35,000 Dalton.

The hydrophobic cobalt chelate complex used in the invention process is preferably a cobalt II chelate having the following formula III:

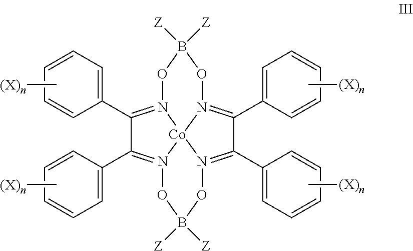

wherein each group X, independently in each ring and in different rings, is a substituent selected from any alkyl but preferably of 1 to 14 carbon atoms or cycloalkyl of 6 to 14 carbon atoms and any aryl but preferably of 6 to 14 carbon atoms;
n, independently in each ring, is 0 to 5;
Z, independently on each boron atom, is selected from F, Cl, Br, OH, alkoxy of 1 to 12 carbon atoms, aryloxy of 6 to 12 carbon atoms, alkyl of 1 to 12 carbon atoms and aryl of 6 to 12 carbon atoms;
or two Z groups taken together provide on one or both boron atoms a group —O-(T)-O— where T is a divalent aryl or alicyclic linking group or an alkylene linking group;
or two Z groups taken together on one or both boron atoms provide a 1,5-cycloctanediyl linking group;
or being a cobalt III analogue of said cobalt II chelate of formula III in which the cobalt atom is additionally covalently bonded, in a direction at right angles to the macrocyclic chelate ring system, to H, halide or other anion, or a homolytically dissociable organic group;
and wherein at least one further ligand may or may not be coordinated to the cobalt II or cobalt III atom, being a ligand(s) which does not alter the cobalt valency state.

The hydrophobic cobalt chelate may also be a Co II chelate having the following formula IV:

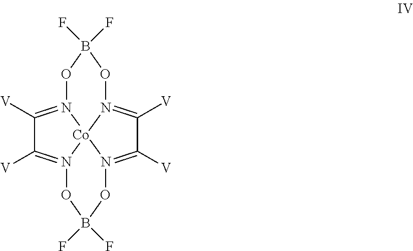

where V is any alkyl group of ≧4 carbon atoms.

Referring now to Formula III, preferably X is alkyl of 1 to 14 carbon atoms, and may be straight-chained or branched if the option arises. More preferably X is alkyl of 1 to 4 carbon atoms and particularly is methyl.

It is possible for n (representing the number of substituents in a ring) to be 0 in all rings (i.e. all the rings are unsubstituted so that each ring is phenyl). Preferably, n is 1 to 5 in at least two rings and more preferably n is 1 to 5 in at least three rings and in particular n is 1 to 5 in all four rings.

Preferably n is 1 to 3 in a substituted ring, more preferably n being 1 or 2.

Preferably, when n is 1 to 3 in a substituted ring it has the same value in each ring (if more than one ring is substituted), and more preferably n is 1 or 2, and particularly n is 1 in each substituted ring.

When n=2, the substituents are preferably in the 3, 4 or 2, 4 positions.

When n=1, the substituent may be in the 2, 3 or 4 positions of a ring, preferably being at the same position in all substituted rings. It is particularly preferred that the substituent is at the 2, 3 or 4 position of all four rings, and especially at the 4 position of all four rings.

The groups Z are preferably all the same (or when taken together to form a divalent group such groups are the same on both boron atoms) and more preferably are all F.

When both Z groups together provide a group —O-(T)-O— where T is a divalent aryl or alicyclic linking group, the group T preferably has 6 to 10 carbon atoms and in such cases linkage is from adjacent ring carbon atoms; more preferably T is o-phenylene or 1,2-cyclohexanediyl.

It is more preferred that the Co chelate of Formula III has the following specific Formula V corresponding to Co II (bis 4,4′-dimethylbenzildioxime diborondifluoride):

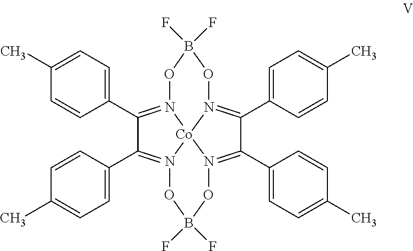

Specific examples of such hydrophobic Co chelate complexes of Formula III where X is alkyl are disclosed in U.S. Pat. No. 5,962,609 reference to which is incorporated herein.

The macromonomers made using the invention process are useful in a variety of applications where they may be used as such, or polymerised with further olefinically unsaturated monomer(s) to form graft copolymers, resulting e.g. in a comb-like chain morphology. Such further monomer(s) could usefully be or include e.g. (meth)acrylic monomer(s) and might e.g. comprise ≦40 weight % of the further monomers polymerised, more preferably ≦60 weight %. Such graft copolymers could usefully be prepared as an extension of the process to form the macromonomer, i.e. the further monomer(s) polymerised being second stage monomers, with the further polymerisation being carried out in the same or a different reactor.

The macromonomers, or graft polymers derived therefrom, are particularly suitable for use in coatings applications in which they may provide a key part of the coating compositions or formulations. Such coating compositions which can be pigmented or unpigmented will usually be waterborne coating compositions since the macromonomer thereof has been derived from aqueous emulsion polymerisation.

The coating compositions may be used for coating a variety of substrates such as metals, wood, paper, board, leather, textiles, cementitious materials, polymeric films or other plastics articles.

A further coating use for the macromonomers by the invention process, or graft copolymers derived therefrom, is in graphics arts applications, wherein they may provide important components of water-based inks and overprint varnishes.

Yet a further use for the macromonomers made by the invention process is in adhesives applications, wherein they, or products derived from them, may be employed in pressure sensitive, hot melt, contact and laminating adhesives compositions. Such adhesives compositions may be water-based or of the hot-melt-type.

The present invention is now illustrated but in no way limited by reference to the following examples. Unless otherwise specified all parts, percentages and ratios are on a weight basis (and the amount in parts for any component refers to that based on the total of all components being used, including liquids such as water, and not just on the total of solids). The prefix C before an example number denotes that it is comparative.

In the examples, the following abbreviations and terms are specified:
MMA methyl methacrylate
BA n-butyl acrylate
MAA methacrylic acid
DAAM diacetone acrylamide
HEMA hydroxyethyl methacrylate
AAEM acetacetoxyethyl methacrylate
MPEG-350 ω-methoxypolyethyleneglycol methacrylate of Mw 350
Mn number average molecular weight
Mw weight average molecular weight
MM macromonomer
SLS sodium lauryl sulphate (100%)
CCTP catalytic chain transfer polymerisation
GPC gel permeation chromatography
CTA chain transfer agent
Co 4-MePhBF Co II (bis 4,4′-dimethylbenzil dioxime diborondifluoride) (Formula V in description)
PS particle size
n.d. not done

Molecular weights were determined by GPC relative to polystyrene standards.

### Preparation of Hydrophilic Oligomers

Hydrophilic oligomers for use as a stabilising substance in the invention process were prepared using the following procedure, these oligomers being obtained from the monomer compositions shown in Table 1 below.

In a round-bottomed flask equipped with a stirrer and reflux condenser, 64.31 parts of water and 0.08 parts of surfactant (SLS) were mixed and heated to 85° C. 5 weight % of a pre-emulsified feed of 20.09 parts of monomers as shown in Table 1, 8.57 parts of water, 0.25 parts of SLS and 0.48 parts in Examples 1 to 13 and 0.14 parts in Examples 14 to 19 of CTA (3-mercaptopropionic acid) was added to the reactor phase at 60° C. 0.02 parts of ammonium persulphate initiator dissolved in 1.19 parts of water was added to the reactor phase at 80° C. At reaction temperature the remaining monomer feed was added over a period of 60 minutes. An initiator feed of 0.04 parts of ammonium persulphate dissolved in 2.77 parts of water was added over a period of 70 minutes. When the initiator feed had been completed the reaction mixture was kept at 85° C. for 20 minutes. After 20 minutes the temperature was reduced to 80° C. The pH of the reactor phase was increased to 9 using a mixture of 2.2 parts aqueous NH₃ (15.5% weight/weight in water). After 20 minutes mixing at 80° C. the emulsion was cooled to room temperature and filtered. Typically the final product had a pH of 8.0 and a solids content of 21%. The molecular weight data for the hydrophilic oligomers formed is given in Table 1 below.

### EXAMPLES 1 TO 19

Macromonomers of MMA were prepared according to the invention process in these examples using a precharge of a solution of Co chelate in MMA which was emulsified in water using the hydrophilic oligomers (as aqueous dispersions) prepared as described above as the stabilising substance and then partially polymerised to form mixture A (embodiment G′ of the invention process).

In a round-bottomed flask (the reactor) equipped with a stirrer and reflux condenser 0.75 parts of the hydrophilic oligomer (as aqueous dispersion) was mixed with 0.75 parts of a preformed solution of Co 4-MePhBF (CTA) in MMA at room temperature. The amount of cobalt chelate in each example is shown in Table 1. After mixing for 1 hour at room temperature the emulsified mixture was diluted with 58 parts of water and heated to 75° C. thereby forming a pre-emulsified mixture. At 75° C., 0.008 parts of ammonium persulphate (APS) initiator dissolved in 0.3 parts of water were added to the reactor phase to start the polymerisation in the pre-emulsified mixture in the reactor and the reactor phase was further heated to 85° C. The reactor phase was kept at 85° C. for 10 minutes, thereby to form pre-emulsified mixture A, embodiment G′. At this point a monomer feed stage MF, being 29.25 parts of MMA, and a (separate) APS initiator feed, comprising 0.142 parts of initiator and 5.7 parts of water and optionally 0.03 parts of SLS at a pH of 8.5, to the reactor were started. The monomer feed and (separate) initiator feed were added over a period of 240 minutes. Following the addition of the monomer feed the monomer feed tank was rinsed with 5 parts of water, the rinsings added to the reactor, and the polymerisation mixture kept at 85° C. for 90 minutes. The emulsion was cooled to room temperature and filtered. The final macromonomer aqueous emulsion typically had a solids content of 30%, a pH of 8.5 and a viscosity of 10 mPa·s. The particle sizes of the macromonomers are shown in Table 1 below.

TABLE 1

| | | Mw (kD) | Wt ppm * | | SLS in | |
|---|---|---|---|---|---|---|
| Ex. | Monomer composition for | hydrophilic | Cobalt | Mw MM | initiator | PS MM |
| No | hydrophilic oligomer | oligomer | chelate | (kD) | feed | (nm) |
| 1 | MMA/BA/MAA/DAAM = 50/34/10/8 | 12 | 10 | 21.5 | no | n.d. |
| 2 | MMA/MAA/HEMA = 82/8/10 | 11 | 10 | 34.1 | yes | 76 |
| 3 | MMA/MAA/AAEM = 82/8/10 | 10 | 10 | 31.3 | yes | 79 |
| 4 | MMA/AAEM = 90/10 | 11 | 10 | 55.6 | yes | 336 |
| 5 | MMA/MAA/DAAM = 82/8/10 | 11 | 40 | 10.8 | yes | 94 |
| 6 | MMA/MAA/DAAM = 84/6/10 | 11 | 40 | 16.2 | yes | 70 |
| 7 | MMA/MAA/HEMA = 82/8/10 | 11 | 40 | 9.2 | no | 61 |
| 8 | MMA/MAA/HEMA = 82/8/10 | 11 | 40 | 11 | yes | 78 |
| 9 | MMA/MAA/AAEM = 82/8/10 | 10 | 40 | 6.9 | no | 80 |
| 10 | MMA/MAA/AAEM = 82/8/10 | 10 | 40 | 7.7 | yes | 73 |
| 11 | MMA/MAA/MPEG-350 = 82/8/10 | 11 | 40 | 11.5 | no | 69 |
| 12 | MMA/MAA/MPEG-350 = 82/8/10 | 11 | 40 | 12.2 | yes | 67 |
| 13 | MMA/BA/MAA/DAAM = 41/41/8/10 | 10 | 10 | 24.1 | yes | 119 |
| 14 | MMA/MAA/DAAM = 82/8/10 | 33 | 10 | 54.3 | no | 154 |
| 15 | MMA/MAA/DAAM = 84/6/10 | 27 | 10 | 51.8 | no | 128 |
| 16 | MMA/BA/MAA/DAAM = 41/41/8/10 | 28 | 10 | 43.8 | no | 48 |
| 17 | MMA/MAA/HEMA = 82/8/10 | 27 | 40 | 10.3 | yes | 43 |
| 18 | MMA/MAA/AAEM = 82/8/10 | 28 | 40 | 23.3 | yes | 43 |
| 19 | MMA/MAA/MPEG-350 = 82/8/10 | 29 | 40 | 12.3 | yes | 70 |

* based on total weight monomer used.

### EXAMPLES 20 TO 24

Macromonomers of MMA were prepared according to the invention process using a precharge of a solution of Co chelate in MMA which was emulsified in water using SLS as the stabilising substance (instead of hydrophilic oligomer as used in Examples 1 to 19 above) and then partially polymerised to form mixture A (embodiment G′ of the invention process).

In a round-bottomed flask (the reactor) equipped with a stirrer and reflux condenser X parts of SLS (see Table 2) were mixed with 0.75 parts of a preformed solution of Co 4-MePhBF (CTA) in MMA at room temperature. The total amount of stock solution (MMA plus cobalt chelate) was 0.75 parts in total; however the amount of Co chelate was so low that this was very nearly the same as 0.75 parts of MMA. After mixing for 1 hour at room temperature the precharge was diluted with 58 parts of water and heated to 75° C. At 75° C., 0.008 parts of ammonium persulphate initiator dissolved in 0.3 part of water was added to the reactor phase to start the polymerisation of the MMA in the precharge and the reactor phase was further heated to 85° C. The reactor phase was kept at 85° C. for 10 minutes, thereby to form mixture A (embodiment G′). At this point the monomer feed stage MF (29.25 parts of MMA) and a (separate) APS initiator feed, comprising 0.142 parts of the initiator and 5.7 parts of water and optionally 0.03 parts of further SLS to the reactor was started. The monomer feed and initiator feed were added over a period of 240 minutes. Following the addition of the monomer feed the feed tank was rinsed with 5 parts of water, the rinsings added to the reactor, and the polymerisation mixture kept at 85° C. for 90 minutes. The emulsion formed was cooled to room temperature and filtered. The final macromonomer aqueous emulsion typically had a solids content of 30%, a pH value of 3 and a viscosity of 10 mPa·s. The Mw and particle sizes of the macromonomers are shown in Table 2 below.

TABLE 2

| Ex. | % SLS on | Parts SLS | Wt ppm * | Mw MM | PS MM |
|---|---|---|---|---|---|
| No. | monomer * | on total | Cobalt chelate | (kD) | (nm) |
| 20 | 2.3% | 0.69 | 50 | 35 | 22 |
| 21 | 2.0% | 0.60 | 50 | 32 | 28 |
| 22 | 1.5% | 0.45 | 50 | 43 | 22 |
| 23 | 1.0% | 0.30 | 50 | 24 | 18 |
| 24 | 1.5% | 0.45 | 25 | 25 | 17 |

* based on total weight of monomer used.

### EXAMPLES 25 AND 26

Macromonomers of MMA were prepared according to the invention process using a precharge of a solution of Co chelate in MMA which was emulsified in water using hydrophilic oligomers (and not polymerised) to form mixture A, embodiment G′.

In a round-bottomed flask (the reactor) equipped with a stirrer and reflux condenser 47.169 parts of the hydrophilic oligomer (as aqueous dispersion) was mixed with 14.151 parts of a preformed solution of Co 4-MePhBF (CTA) in MMA at room temperature (effectively 14.15 parts of MMA). The amount of cobalt chelate in each example is shown in Table 3. After mixing for 1 hour at room temperature the emulsified mixture was diluted with 1196.2 parts of water and heated to 85° C. At 85° C., the monomer feed stage MF, being 566.03 parts of MMA, and a (separate) APS initiator feed, comprising 2.83 parts of initiator and 110.37 parts of water and optionally 9.434 parts of SLS at a pH of 8.5, to the reactor were started. The monomer feed and (separate) initiator feed were added over a period of 240 minutes. Following the addition of the monomer feed the monomer feed tank was rinsed with 53.8 parts of water, the rinsing added to the reactor, and the polymerisation mixture kept at 85° C. for 90 minutes. The emulsion was cooled to room temperature and filtered. The final macromonomer aqueous emulsion typically had a solids content of 30%, a pH of 8.5 and a viscosity of 10 mPa·s. The Mw and particle sizes of the macromonomers are shown in Table 3 below.

TABLE 3

| | | | Wt ppm * | | SLS in | |
|---|---|---|---|---|---|---|
| Ex. | Hydrophilic oligomer | | Cobalt | Mw MM | initiator | PS MM |
| No | Monomer composition | Mw(kD) | chelate | (kD) | feed | (nm) |
| 25 | MMA/MAA/HEMA = 82/8/10 | 11 | 10 | 39 | yes | 78 |
| 26 | MMA/MAA/HEMA = 82/8/10 | 11 | 40 | 10 | yes | 80 |

### EXAMPLES 27 AND 28

Macromonomers of MMA were prepared according to the invention process using a precharge of a solution of Co chelate, stabilised using a hydrophilic oligomer or a surfactant and (i) a non-polymerisable organic solvent to form mixture A (embodiment G).

In a round-bottomed flask (the reactor) equipped with a stirrer and reflux condenser 35.38 parts of the hydrophilic oligomer (as aqueous dispersion) or 21.428 parts of SLS (aqueous solution was mixed with 10.61 parts of a preformed solution of Co 4-MePhBF (CTA) in toluene at room temperature (effectively 10.61 parts of toluene). The amount of cobalt chelate in each example is shown in Table 4. After mixing for 1 hour at room temperature the emulsified mixture was diluted with 906.08 parts of water and heated to 85° C. At 85° C., the monomer feed stage MF (424.52 parts of MMA) and a (separate) APS initiator feed, comprising 2.12 parts of initiator and 82.77 parts of water and optionally 7.075 parts of SLS at a pH of 8.5, to the reactor were started. The monomer feed and (separate) initiator feed were added over a period of 240 minutes. Following the addition of the monomer feed the monomer feed tank was rinsed with 40.35 parts of water, the rinsing added to the reactor, and the polymerisation mixture kept at 85° C. for 90 minutes. The emulsion was cooled to room temperature and filtered. The final macromonomer aqueous emulsion typically had a solids content of 30%, a pH of 8.5 and a viscosity of 10 mPa·s. The Mw and the particle sizes of the macromonomers are shown in Table 4.

TABLE 4

| | | Wt ppm * | | SLS in | |
|---|---|---|---|---|---|
| Ex. | | Cobalt | Mw MM | initiator | PS MM |
| No | Stabilising compound | chelate | (kD) | feed | (nm) |
| 27 | Oligomer MMA/ | 10 | 52 | yes | 66 |
| | MAA/HEMA = 82/8/10 | | | | |
| 28 | 1.5% on | 10 | 42 | yes | 40 |
| | monomer SLS | | | | |

### COMPARATIVE EXAMPLE 29

This was a comparative example in which a macromonomer of MMA was prepared using a monomer feed process not according to the invention, using a mixture A with weight ratio of MMA to SLS outside 10/1 to 1/10.

In a round bottomed flask equipped with a stirrer and reflux condenser 59.36 parts of water and 0.18 parts of the initiator 4,4′-azobis(4-cyanovaleric acid) were mixed and heated to 85° C. As soon as the polymerisation temperature was reached, 10% of a monomer feed comprising 9.78 parts of water, 1.22 parts of SLS (30 wt %), 600 weight ppm of Co 4-MePhBF (CTA) (based on total MMA used) and 24.44 parts of MMA was added. This was allowed to react for 5 minutes before the remainder of the monomer feed was added over a period of 90 minutes. Following the addition of the monomer feed the feed tank was rinsed with 5 parts of water, the rinsings added to the reactor, and the polymerisation mixture kept at 80° C. for 30 minutes. The emulsion was cooled to room temperature and filtered. The resulting macromonomer aqueous emulsion had a solids content of 25%, a pH of 3.2 and a viscosity of 5 mPa·s. Mw of the macromonomer was 42 kD, i.e. higher than those of most of the above-exemplified macromonomers made by the invention process, (in a few cases comparable to them) even though 12 to 60 times as much Co chelate catalyst was used. The Mw and particle size is shown in Table 5 below.

### COMPARATIVE EXAMPLE 30

This was a comparative example in which no mixture A was used.

In a round bottomed flask equipped with a stirrer and reflux condenser 1181.9 parts of water and 7.28 parts of the initiator 4,4′-azobis(4-cyanovaleric acid) were mixed and heated to 85° C. As soon as the polymerisation temperature was reached, the monomer feed comprising 201.12 parts of water, 12.13 parts of SLS (30 wt %), 40 weight ppm of Co 4-MePhBF (CTA) (based on total MMA used) and 485.25 parts of MMA was added over a period of 90 minutes. Following the addition of the monomer feed the feed tank was rinsed with 100 parts of water, the rinsing added to the reactor, and the polymerisation mixture kept at 85° C. for 30 minutes. The emulsion was cooled to room temperature and filtered. The resulting macromonomer aqueous emulsion had a solids content of 25%, a pH of 3.2 and a viscosity of 10 mPa·s. The Mw and particle size is shown in Table 5 below.

### COMPARATIVE EXAMPLES 31 AND 32

These are comparative examples where a mixture A with a weight ratio of MMA to SLS outside 10/1 to 1/10 and with 10 or 40 weight ppm of CTA was used.

In a round bottomed flask equipped with a stirrer and reflux condenser 1181.9 parts of water and 7.28 parts of the initiator 4,4′-azobis(4-cyanovaleric acid) were mixed and heated to 85° C. As soon as the polymerisation temperature was reached, 10% of the monomer feed comprising 201.12 parts of water, 12.13 parts of sodium lauryl sulphate (30 wt-%), 10 or 40 weight ppm of Co 4-MePhBF (CTA) (based on total MMA used) and 485.25 parts of MMA was added. The reaction mixture was kept for 5 minutes at 85° C. Then the remaining monomer feed was added to the reaction mixture over a period of 90 minutes. Following the addition of the monomer feed the feed tank was rinsed with 100 parts of water, the rinsings added to the reactor, and the polymerisation mixture kept at 85° C. for 30 minutes. The emulsion was cooled to room temperature and filtered. The resulting macromonomer aqueous emulsion had a solids content of 25%, a pH of 3.2, and a viscosity of 10 mPa·s. The Mw and particle size is shown in Table 5 below.

TABLE 5

| | | Wt ppm * | | |
|---|---|---|---|---|
| C. Ex. | | Cobalt | Mw MM | PS MM |
| No | Adjustments | chelate | (kD) | (nm) |
| 29 | Ratio of MMA to SLS in | 600 | 42 | 150 |
| | A outside 10/1 to 1/10 | | | |
| 30 | No mixture A | 40 | 76 | 120 |
| 31 | Ratio of MMA to SLS in | 10 | 96 | 128 |
| | A outside 10/1 to 1/10 | | | |
| 32 | Ratio of MMA to SLS in | 40 | 75 | 140 |
| | A outside 10/1 to 1/10 | | | |

1. Macromonomer made using a free radical-initiated aqueous emulsion polymerisation process in a polymerisation reactor of at least one olefinically unsaturated monomer, which process employs a hydrophobic Co chelate catalyst(s) as a catalytic chain transfer agent(s) for controlling molecular weight, a stabilising substance(s) for the emulsion polymerisation process, and a monomer feed stage MF in which olefinically unsaturated monomer(s) to be polymerised is fed to a polymerisation reaction medium in the reactor and polymerised therein; wherein
an aqueous pre-emulsified mixture A, comprising at least part of the Co chelate(s) employed in the process, at least part of the stabilising substance(s) employed in the process, and (i) a non-polymerisable organic solvent(s) and/or (ii) a polymerisable olefinically unsaturated monomer(s) in unpolymerised or at least partially polymerised form, is contacted in the reactor with monomer(s) of feed stage MF at the beginning of and/or during the course of feed stage ME; and wherein
in mixture A the weight ratio of (i) non-polymerisable organic solvent(s) and/or (ii) polymerisable olefinically unsaturated monomer(s) in unpolymerised or at least partially polymerised form to stabilising substance(s) is in the range of from 10/1 to 1/10, wherein
the macromonomer contains ≦60 weight parts per million of the Co Chelate catalyst(s) based on the total weight of monomer(s) used for the polymerization, wherein
the macromonomer has at least 90% of terminal unsaturation in its polymer chains, and wherein
said olefinically unsaturated monomer(s) used to form the macro-monomer comprises at least 20 weight % of at least one (co)polymerisable α-methyl vinyl monomer for the monomer(s) used to form the macro-monomer (based on total monomer weight used for the polymerisation) where said α-methyl vinyl monomer has the formula
CH₂═C(CH₃)-Q II
where Q is the residue of the monomer molecule and is selected from one or more of: a carbon acid group of formula C(═O)OR³ or a carbon amide group of formula C(═O)NHR³ where R³ is H, optionally substituted C₁₋₁₈ alkyl, optionally substituted aryl and optionally substituted alkaryl; CN; and optionally substituted aryl.

2. Macromonomer according to claim 1 which has a weight average molecular weight within the range of from 2,000 to 100,000 Dalton.

3. Graft copolymer made by polymerisation of a macromonomer according to claim 1.

4. A coating comprising a macromonomer according to claim 1.

5. A coating according to claim 4 which is at least one of a film coating and an overprint varnish.

6. An adhesive which comprises a coating according to claim 4.

7. Macromonomer according to claim 1 wherein said pre-emulsified mixture A comprises a non-polymerisable organic solvent(s) (but not a polymerisable olefinically unsaturated monomer(s) in unpolymerised or at least partially polymerised form).

8. Macromonomer according to claim 1 wherein said pre-emulsified mixture A comprises a polymerisable olefinically unsaturated monomer(s) in unpolymerised or at least partially polymerised form (but not a non-polymerisable organic solvent(s).

9. Macromonomer according to claim 1 wherein said pre-emulsified mixture A comprises a non-polymerisable organic solvent(s) and a polymerisable olefinically unsaturated monomer(s) in unpolymerised or at least partially polymerised form.

10. Macromonomer according to claim 1 wherein the aqueous pre-emulsified mixture A, comprising at least part of the Co chelate(s) employed in the process used to make the macro-monomer, at least part of the stabilising substance(s) employed in the process used to make the macro-monomer, and (ii) a polymerisable olefinically unsaturated monomer(s) which is in at least partially polymerised form, is prepared in or added to the reactor prior to the commencement of the monomer feed stage MF.

11. Macromonomer according to claim 1 wherein said olefinically unsaturated monomer(s) in mixture A is selected from one or more of methyl methacrylate, ethyl methacrylate and n-butyl methacrylate.

12. Macromonomer according to claim 1 wherein all of the aqueous pre-emulsified mixture A is contacted in the reactor with monomer(s) of feed stage MF at the beginning of the monomer feed stage.

13. Macromonomer according to claim 1 that contains ≦35 weight ppm of Co chelate(s) based on the total weight of monomer(s) used for the polymerisation.

14. Macromonomer according to claim 13 that contains ≦20 weight ppm of Co chelate(s) based on the total weight of monomer(s) used for the polymerisation.

15. Macromonomer according to claim 1 wherein the amount of Co chelate(s) employed in mixture A is from 10 to 100 weight % based on the total weight of Co chelate employed in the polymerisation.

16. Macromonomer according to claim 1 wherein in mixture A the amount of (i) non-polymerisable organic solvent(s) and/or (ii) polymerisable olefinically unsaturated monomer(s) in unpolymerised or at least partially polymerised form before contact with monomer(s) of feed stage MF is within the range of 1 to 20 weight % based on total monomer(s) used for the polymerisation.

17. Macromonomer according to claim 1 where the macro-monomer is in the form of particles dispersed in an aqueous emulsion and where the marco-monomer particle size, as measured with light scattering equipment, is within the range of from 10 to 300 nm.

18. Macromonomer according to claim 1 wherein the stabilising substance(s) employed in mixture A is a surfactant and/or a hydrophilic oligomer.

19. Macromonomer according to claim 18, wherein said hydrophilic oligomer(s) is an acrylic oligomer(s) and/or a polyurethane oligomer(s).

20. Macromonomer according to claim 1 wherein said olefinically unsaturated monomer(s) used to form the macro-monomer is selected from one or more of olefinically polyunsaturated monomers such as 1,3-butadiene isoprene; polyalkylene glycol di(meth)acrylates; divinyl benzene; monolefinically unsaturated monomers such as styrenes; meth(acrylic) amides and (meth)acrylonitrile; vinyl halides; vinylidine halides; fluoro-containing vinyl monomers; vinyl ethers; vinyl esters; heterocyclic olefinically unsaturated compounds; olefinically unsaturated acids; alkyl esters of mono-olefinically unsaturated dicarboxylic acids; monosubstituted alkyl esters of monoolefinically unsaturated dicarboxylic acids; esters of acrylic acid and methacrylic acid of formula CH₂═CR¹—COOR² wherein R¹ is H or methyl and R² is optionally substituted alkyl of 1 to 20 carbon atoms or cycloalkyl of 5 to 20 carbon atoms.

21. Macromonomer according to claim 1 wherein said α-methyl vinyl monomer(s) is selected from methacrylic acid, C₁ to C₁₆ normal or branched alkyl esters of methacrylic acid; hydroxyalkyl methacrylates; glycidyl methacrylate; phenyl methacrylate; methacrylamide; methacrylonitrile; triethyl fluoro methacrylate; alpha methyl styrene; polyethylene glycol (PEG) methacrylates; methoxypolyethylenglycol (MPEG) methacrylates, or combinations thereof.

22. Macromonomer according to claim 1 wherein the maximum amount of Co catalyst in the mixture A when (co)polymerising an α-methyl vinyl monomer(s) of formula
CH₂═C(CH₃)-Q′ II
where Q′ is the residue of the monomer molecule and is selected from one or more of: a carbon acid group of formula C(═O)OR⁴ or a carbon amide group of formula C(═O)NHR⁴, where R⁴ is optionally substituted C₁₋₁₈ alkyl, optionally substituted aryl and optionally substituted alkaryl; CN; and optionally substitute aryl,
is governed by the following empirical relationship:
Mw[Co-complex]/m^{1/2}<0.35 Dalton I
where
Mw is the achieved weight average molecular weight of the macro-monomer in Dalton;
[Co-complex] is the concentration of Co chelate catalyst(s) in mixture A in mol based on total monomer(s) used in the process to form the macro-monomer; and
m is the average number of carbon atoms of the alkyl, aryl or aralkyl substituent(s) of the α-methyl vinyl monomer(s) (or the weight average number of the number of carbon atoms of such substituents if using more than one α-methyl vinyl monomer).

23. Macromonomer according to claim 1 which is an acrylic macro-monomer.

24. Macromonomer according to claim 1 wherein the monomer(s) used to form the macro-monomer includes a functional monomer(s) carrying a crosslinker group(s).

25. Macromonomer according to claim 1 wherein the monomers used to form the macro-monomer include an olefinically unsaturated acid monomer(s) in an amount within the range of from 5 to 20 weight % based on the total amount of monomers used.

26. Macromonomer according to claim 1, wherein the hydrophobic Co chelate used has Formula III 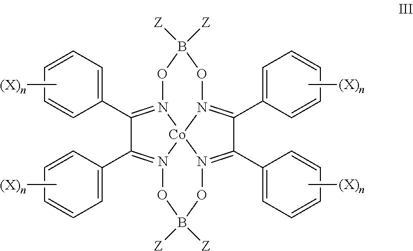
wherein each group X, independently in each ring and in different rings, is a substituent selected from any alkyl and any aryl;
n, independently in each ring, is 0 to 5;
Z, independently on each boron atom, is selected from F, Cl, Br, OH, alkoxy of 1 to 12 carbon atoms, aryloxy of 6 to 12 carbon atoms, alkyl of 1 to 12 carbon atoms, and aryl of 6 to 12 carbon atoms;
or two Z groups taken together provide on one or both boron atoms a group —O-(T)-O— where T is a divalent aryl or alicyclic linking group or an alkylene linking group;
or two Z groups taken together on one or both boron atoms provide a 1,5-cycloctanediyl linking group;
or being a cobalt III analogue of said cobalt II chelate of formula III in which the cobalt atom is additionally covalently bonded, in a direction at right angles to the macrocyclic chelate ring system, to H, halide or other anion, or a homolytically dissociable organic group.

27. Macromonomer according to claim 26, wherein said Co chelate used has Formula V:

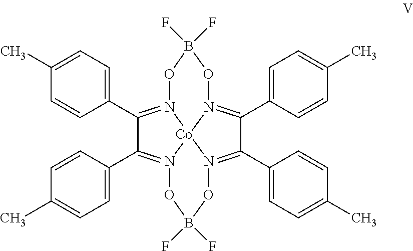

28. Macromonomer according to claim 1, wherein the Co chelate used has Formula IV: 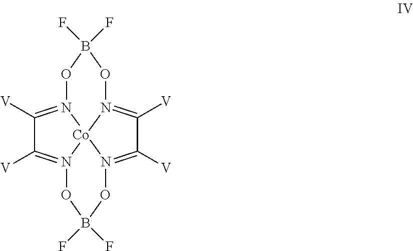
where V is any alkyl group of >4 carbon atoms.

29. Macromonomer according to claim 1, wherein mixture A comprises a polymerisable olefinically unsaturated monomer(s) in at least partially polymerised form, which is stored and used at a later time in the process used to form the macro-monomer.

30. Macromonomer according to claim 29, wherein mixture A comprises a polymerisable olefinically unsaturated monomer(s) in substantially fully polymerised form.

31. Macromonomer according to claim 30, wherein mixture A is stored for at least 1 day before subsequent use in the process used to form the macro-monomer.
